(19) United States
(12) Patent Application Publication
(10) Pub. No.: US 2025/0186948 A1
(43) Pub. Date: Jun. 12, 2025

(54) SUSTAINABLE NUTRIENT WATER RECOVERY BY HYBRID ELECTRODIALYSIS - FORWARD OSMOSIS PROCESS

(71) Applicant: Oregon State University, Corvallis, OR (US)

(72) Inventors: Xue Jin, Corvallis, OR (US); Quang Tran, Corvallis, OR (US)

(73) Assignee: Oregon State University, Corvallis, OR (US)

(21) Appl. No.: 18/923,444

(22) Filed: Oct. 22, 2024

Related U.S. Application Data
(60) Provisional application No. 63/671,565, filed on Jul. 15, 2024.
(60) Provisional application No. 63/545,426, filed on Oct. 24, 2023.

(51) Int. Cl. B01D 61/58; B01D 61/00; B01D 61/46; C02F 1/44; C02F 1/469

(52) U.S. Cl. CPC B01D 61/58; C02F 1/445; C02F 1/4693; B01D 61/0022; B01D 61/005; B01D 61/46; B01D 2317/02; B01D 2317/08; C02F 2301/046; C02F 2303/04

(57) ABSTRACT

An integrated electrodialysis/forward osmosis process and system.

### CROSS REFERENCE TO RELATED APPLICATION

This application claims the benefit of U.S. Provisional Application No. 63/545,426, filed Oct. 24, 2023, and U.S. Provisional Application No. 63/671,565, filed Jul. 15, 2024, all of which are incorporated herein in their entireties.

### ACKNOWLEDGMENT OF GOVERNMENT SUPPORT

This invention was made with government support under grant 2023-67019-39701 awarded by the U.S Department of Agriculture and the National Institute of Food and Agriculture. The government has certain rights in the invention.

### BACKGROUND

The agriculture sector is the largest freshwater consumer in the United States, accounting for up to 70% of available freshwater withdrawals. However, water shortage has been exacerbated and becoming a critical problem in many regions of the country where more frequent and intense droughts are expected. Given that water shortages in agriculture can have far-reaching effects on food security, more and more regions see irrigation with reclaimed water as an opportunity to secure and enhance agricultural production. Despite the benefits of water reuse, problems concerning the release of organic micropollutants, wastewater-borne antibiotics, antibiotic-resistant bacteria (ARB), and their determinant genes (antibiotic-resistance genes (ARGs)) into the environment and food crops irrigated with treated wastewater are starting to gain attention. For these reasons, there is a critical need for effective treatment technologies that provide safe reclaimed water for agricultural irrigation.

### SUMMARY

In one aspect, disclosed herein is a method comprising:
introducing liquid digestate that includes at least one organic contaminant, at least one microbial contaminant, and at least one charged nutrient species into an electrodialysis system thereby separating the liquid digestate into (a) a contaminant-rich diluate stream that includes the at least one organic contaminant and the at least one microbial contaminant and (b) a nutrient species-rich concentrate stream that includes the at least one nutrient species; and
introducing the diluate stream into a forward osmosis system as a feed stream and simultaneously introducing the nutrient species-rich concentrate stream into the forward osmosis system as a draw stream thereby producing (c) a water product that includes the at least one nutrient species and that is substantially free of the at least one organic contaminant and the at least one microbial contaminant and (d) a waste stream that includes the at least one organic contaminant and the at least one microbial contaminant.

Also disclosed herein is a system comprising:
an electrodialysis stage that includes an inlet for receiving a liquid digestate that includes at least one organic contaminant, at least one microbial contaminant, and at least one charged nutrient species, a first outlet for a contaminant-rich diluate stream that includes the at least one organic contaminant and the at least one microbial contaminant, and a second outlet for a nutrient species-rich concentrate stream that includes the at least one nutrient species; and
a forward osmosis stage having a draw side and a feed side, wherein the draw side is in fluid communication with the nutrient species-rich concentrate stream and the feed side is in fluid communication with the contaminant-rich diluate stream.

Further disclosed herein is a method comprising:
introducing liquid digestate that includes at least one organic contaminant, at least one microbial contaminant, and at least one charged nutrient species into an electrodialysis stack thereby separating the liquid digestate into (a) a contaminant-rich diluate stream that includes the at least one organic contaminant and the at least one microbial contaminant and (b) a nutrient species-rich concentrate stream that includes the at least one nutrient species; and
directly introducing the diluate stream into a forward osmosis module as a feed stream and simultaneously directly introducing the nutrient species-rich concentrate stream into the forward osmosis module as a draw stream thereby producing (c) a water product that includes the at least one nutrient species and that is substantially free of the at least one organic contaminant and the at least one microbial contaminant and (d) a waste stream that includes the at least one organic contaminant and the at least one microbial contaminant,
wherein a concentration of the charged nutrient species in the concentrate stream is sufficient for generating a stable osmotic pressure difference between the draw stream and the feed stream in the forward osmosis module.

The foregoing will become more apparent from the following detailed description, which proceeds with reference to the accompanying figures.

The foregoing will become more apparent from the following detailed description, which proceeds with reference to the accompanying figures.

### BRIEF DESCRIPTION OF THE DRAWINGS

FIG. 1 is a schematic of a hybrid electrodialysis (ED)—forward osmosis (FO) process for recovery of nutrients and clean water from liquid digestate.

FIG. 2 is a schematic of an ED system.

FIG. 3 is a schematic of a FO system.

FIG. 4 is a graph showing electrical conductivity and current density of the diluate and concentrate streams over time.

FIG. 5 is a graph showing removal and recovery efficiency and concentration factor (CF) of the ED treatment.

FIG. 6 is a graph showing water flux and accumulated permeate volume over time during FO operation.

FIG. 7 is a graph showing average mass of TOC and heavy metals in the initial diluate before ED and final draw solution after FO. R represents the overall removal efficiency of ED-FO treatment, and error bars are the standard deviation from three independent experiments.

FIGS. 8A and 8B are graphs showing (8A) fresh and (8B) dry weights of lettuce and kale plants grown hydroponically for 5 weeks with liquid digestate or nutrient water recovered from ED-FO treatment of wastewater.

FIGS. 9A and 9B show schematic configurations of the ED-FO processes: (FIG. 9A) ED followed by FO (ED→FO) and (FIG. 9B) integrated operation of ED and FO (iEDFO).

FIGS. 10A and 10B. Effects of voltage (FIG. 10A) and flowrate (FIG. 10B) on energy consumption and ionic migration rate. Volume ratio of initial diluate to concentrate: 7.5; stripping efficiency: 90% (n=3) FIG. 11. Specific energy consumption as a function of stripping efficiency. Voltage: 20 V, flowrate: 20 L/h, volume ratio of initial diluate to concentrate: 7.5

FIG. 12. Effect of volume ratio of initial diluate to concentrate on ion transport rate and concentration factor. Voltage: 20 V; flowrate: 20 L/h, stripping efficiency: 99% FIGS. 13A and 13B. Comparison of iEDFO and conventional ED performance for treating synthetic anaerobic digestate: (FIG. 13A) 90% of stripping efficiency, and (FIG. 13B) 99% of stripping efficiency. Experimental conditions: voltage =20 V; flowrate=20 L/h; volume ratio of initial diluate to concentrate=7.5.

FIGS. 14A and 14B. Comparison of iEDFO and conventional ED performance for treating real anaerobic digestate: (FIG. 14A) electrical conductivity in diluate and concentrate streams, and (FIG. 14B) current density. Experimental conditions: voltage =20 V; flowrate=20 L/h; volume ratio of initial diluate to concentrate=7.5; stripping efficiency=90%.

FIGS. 15A and 15B. Fouling mechanisms of AEMs in (FIG. 15A) ED→FO and (FIG. 15B) iEDFO configurations.

FIGS. 16A and 16B. FTIR spectra of (FIG. 16A) AEMs and (FIG. 16B) CEMs used in ED→FO and iEDFO experiments.

FIGS. 17A and 17B. Zeta potential of (FIG. 17A) AEMs and (FIG. 17B) CEMs used in the ED→FO and iEDFO experiments.

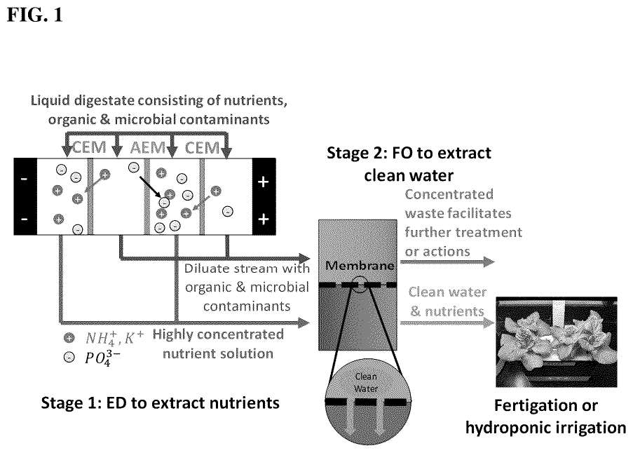

### DETAILED DESCRIPTION

In addition to high quality irrigation water, nutrients are essential for plant growth. Depending on the crop and growing season, plants require anywhere from 50 to 200 mg/L N, 5 to 60 mg/L P, and 15 to 250 mg/L K in the soil solution or growing media. Current economic and environmental impacts of synthetic fertilizer use are not sustainable for multiple reasons. First, ammonia fertilizers are manufactured through the energy-intensive Haber-Bosch process. Second, phosphorus fertilizers are made from phosphate rock, which is a finite resource and will be fully depleted by the end of the century. Third, nutrients pollution from agriculture operations have contaminated a vast amount of freshwater globally, having severe negative impacts on the environment and public health. Municipal and agriculture wastewater presents a significant opportunity for recycling essential plant nutrients. For example, anaerobic digestion is commonly used for waste stabilization. Liquid digestate derived from anaerobic digestion of waste streams is rich in nutrients containing high concentrations of NH₄⁺, PO₄³⁻, and K⁺ ions (see Table 1 below). As such, there is a growing interest in more extensive recovery of nutrients from anaerobically pre-treated waste and using them as easily transportable and marketable products. Highly efficient, cost-effective, compact nutrient recovery systems would be in high demand as revenue and sustainable farming can be achieved. Various technologies have been used to recover nutrients from wastewater. Many of them involve high reagent and/or energy requirements, which can lead to a negative environmental impact. For example, NH₄⁺ and PO₄³⁻ can be removed simultaneously from the soluble phase by struvite formation. The primary drawback to carry out struvite precipitation includes high costs of chemical compounds and the presence of organic contaminants from waste. Air stripping is recognized as an effective technology for ammonia recovery. However, ammonia stripping consumes a great deal of energy and is usually costly. Thus, a technological gap exists in providing efficient nutrient recovery and reuse from liquid digestate while maintaining affordability and sustainability.

TABLE 1
Ion composition of liquid digestate derived from various waste (mg/L)

| Source of | | | | | | | | | | | |
|---|---|---|---|---|---|---|---|---|---|---|---|
| waste | NH₄⁺ | NO₃⁻ | NO₂⁻ | PO₄³⁻ | K⁺ | Na⁺ | Ca²⁺ | Mg²⁺ | Cl⁻ | SO₄²⁻ | Reference |
| Co-digestion | 1809- | 28- | 0.2- | 671- | 35- | 9- | 2- | 1- | 4- | 3.7 | [13], |
| of food & | 3192 | 31 | 0.5 | 946 | 150 | 12 | 82 | 11 | 9.8 | | Gresham |
| sewage sludge | | | | | | | | | | | WWTP |
| | | | | | | | | | | | sample |
| Sewage | 1454- | 18- | 0.5- | 366- | 13.2 | 6.4 | 6.7 | 2.8 | 178- | 1.4 | Corvallis |
| sludge | 1666 | 28 | 0.6 | 675 | | | | | 190 | | WWTP |
| | | | | | | | | | | | sample |
| Fruit/ | 2562- | 114- | 0.7- | 822- | 213- | 75- | 9.4- | 3.5- | 30- | 5.2- | Stahlbush |
| vegetable | 2628 | 172 | 1.1 | 1248 | 361 | 128 | 13.2 | 5.2 | 103 | 15.6 | Island farm |
| waste | | | | | | | | | | | sample |

Disclosed herein is a hybrid electrodialysis (ED)—forward osmosis process for recovery of nutrients and clean water from liquid digestate. We have discovered that ED is an ideal process to recover charged nutrient species from wastewater and thus produce liquid nutrient-concentrate suitable for use as a draw solution for FO. In certain embodiments, the hybrid process can be used for direct fertigation of edible food crops through concurrent recovery of nutrients and clean water from anaerobically pre-treated waste.

Electrodialysis (ED) is a proven water treatment technology to remove ionic species from water. It is flexible, tolerant to fouling and thus requires less pre-treatment, resulting in cost savings in both capital and O&M. In ED, an electric potential is applied through a solution to drive ions across ion-selective membranes, producing a concentrated ion-rich concentrate and an ion-stripped diluate.

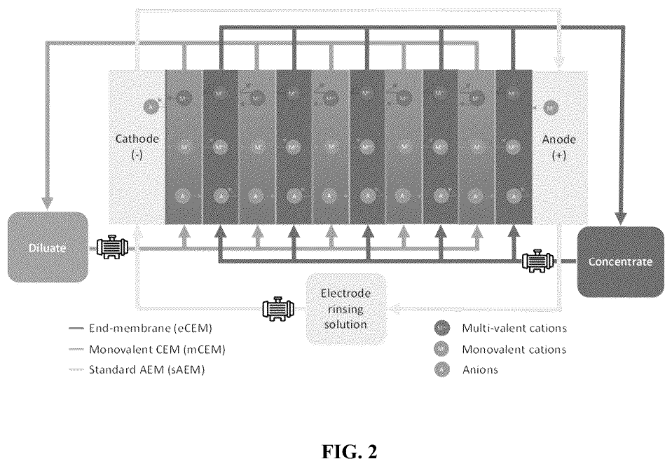

ED is an electrically driven process that utilizes an alternating series of cation exchange membranes (CEMs) and anion exchange membranes (AEMs) placed between a terminal anode and cathode (FIG. 2). When the electrodes are electrically charged, an electrical current flows through the ED stack. Anions move freely through the nearest AEM and are blocked by the nearest CEM. Similarly, cations move through the nearest CEM and are blocked by the nearest AEM. This migration of ions leads to the depletion of ions in the dilute compartments and enrichment of ions in the concentrate compartments.

In certain embodiments, the anode and the cathode are the same material. Illustrative materials include stainless steel, mixed metal oxide (MMO), coated titanium, graphene, and combinations thereof.

Ion exchange membranes are made from different polymer matrixes and different functional groups to provide the ion exchange function of the membranes. An ion exchange membrane typically includes: (1) matrix polymer (support matrix) and (2) functional polymer (contain functional groups for ion exchange). Most commercially available membranes include hydrophobic polymers such as polystyrene, polyethylene or polysulfone and the polymer matrix is usually cross-linked. Polymers containing the following moieties are used as fixed charges in cation exchange membranes: SO₃²⁻, COO⁻, PO₃², and in anion exchange membrane NH₂R, NHR₂, NR₃, PR₃, SR₂.

See Table 2 below for illustrative ion membranes for use in the ED stage disclosed herein.

TABLE 2
Major properties of the selected ion exchange membranes

| | PC SA | PC SK | CSE | ASE |
|---|---|---|---|---|
| Manufacturer | PCA GmbH | PCA GmbH | Neosepta | Neosepta |
| Type | CEM | AEM | CEM | AEM |
| Thickness (mm) | 0.1-0.11 | 0.1-0.12 | 0.16 | 0.15 |
| Electrical Resistance (Ω · ^{cm2}) | 1.8 | 2.5 | 1.8 | 2.6 |
| pH stability | 0-9 | 0-11 | 0-14 | 0-14 |

*Data presented in this table are from the manufacturers

Forward osmosis (FO) is a natural process by which clean water passes from dirty feed water towards a salt ‘draw’ solution with higher osmotic pressure, when the two solutions are separated by a semipermeable membrane. It demonstrates unparalleled advantages of low energy consumption. The concept of fertilizer drawn FO (FDFO), in which commercial fertilizer is used to draw clean water from impaired water sources, has received great interest because water recovered through an FO system is of exceptionally high quality, and the resulting diluted fertilizer draw solution can be applied directly for fertigation. However, FDFO does not address the challenges of phosphorus resource depletion and nutrient pollution. Wastewater, as a major source of nutrient pollution, also presents a significant untapped opportunity for recycling of essential nutrients. Capture and reuse of nutrients from wastewater not only mitigates pollution but also provides an increasingly scarce commodity for global food production. Thus, a feasible technology to recover nutrient species from waste streams and use the nutrient-rich product as a draw solution is critical for the widespread adoption of environmentally sustainable FO processes. The ideal nutrient recovery technology would have the combined characteristics of (1) high recovery efficiency of nutrients, and (2) low energy and chemical consumption.

Illustrative osmotic membrane module configurations for use in the FO stage include: (1) Submerged modules versus side-stream modules; (2) Hollow fiber module versus spiral wound module; and (3) Crossflow direction (for the case of side-stream modules) or aeration management (for the case of submerged modules).

| | Manufacturer | | |
|---|---|---|---|
| | Aquaporin A/S | FTS | Aromatec |
| Material of | Polyamide with | Cellulose | Polyamide |
| rejection layer | aquaporin | triacetate | |
| | protein channels | | |
| Configuration | Hollow fiber | Spiral wound | Hollow fiber |
| Operation | Side-stream | Side-stream | Side-stream |
| mode | | | & submerged |

An ED system will be deployed to extract charged nutrient species from liquid digestate. Due to its superb micropollutant retention, ED treatment will result in two streams: (1) a highly concentrated nutrient solution; and (2) an ion-stripped diluate stream containing organic and microbial contaminants. The nutrient-rich concentrate will be used in the downstream FO process to draw clean water from the remaining nutrient-free stream (diluate stream). Due to its superb retention property, the FO product water is free of organic and microbial contaminants. The final product consisting of clean water and nutrients can be applied at a grower site for direct fertigation. On the other side of the FO membrane, the wastewater volume can be an order of magnitude smaller than that of the original raw water, which can result in significantly reduced footprint and costs for subsequent treatment steps. Such a unique integration of ED and FO is highly attractive in terms of resource recovery, protecting aquatic environment and human health, and reducing footprint and energy cost. The processes and systems disclosed herein can improve agriculture sustainability by turning waste products into assets while reducing environmental impacts.

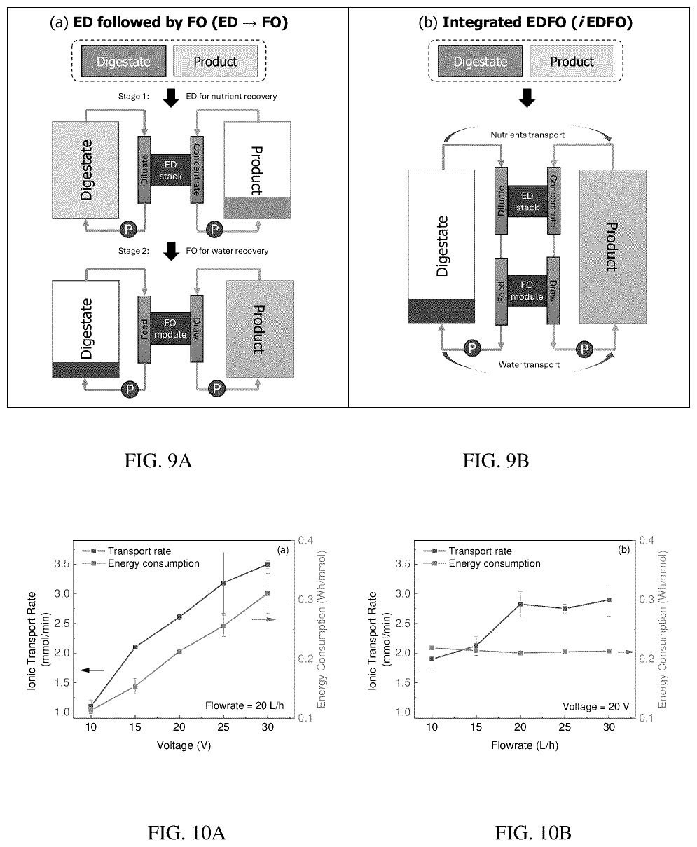

The process comprises (1) ED to recover nutrient ions and (2) FO to extract clean water. Two different configurations can be employed for the process—a two-stage configuration or an integrated configuration. A comparison of the two configurations is shown in FIG. 9.

One configuration is a two-stage configuration process (designated herein as “ED→FO). In Stage 1, liquid digestate flows into an ED cell. When the electrodes are electrically charged, nutrient ions will be pulled into a concentrate compartment, producing a nutrient-rich concentrate and an ion-stripped diluate. To reduce membrane fouling and enhance membrane lifetime, electrode polarity will be reversed at regular time intervals. In Stage 2, the concentrated nutrient solution with high osmotic pressure circulates on the draw side of the FO membrane, while the feed side of the FO membrane is in contact with the ion stripped diluate. It is the natural tendency for clean water to be “pumped” out of the ED diluate and pass into the highly concentrated nutrient solution through the membrane. The diluted nutrient-rich solution, almost free of organic and microbial contaminants can be used for direct fertigation. In certain embodiments, the applied voltage during the ED stage is 1 to 30 V/cell pair, 2 to 30 V/cell pair, 10 to 30 V/cell pair, or 2 to 6 V/cell pair. In certain embodiments, the liquid digestate flow rate introduced into the ED state is 15 to 30 L/h. In certain embodiments, the flow rate is constant through both the ED stage and the FO stages.

Another configuration is an integrated ED and FO operation (designated herein as “iEDFO”). The iEDFO configuration is shown in FIG. 9(B). This configuration integrates an ED stack with an FO module to provide continuous flow of the digestate stream and product stream, thus enabling simultaneous processing of nutrients and clean water recovery. In addition, the digestate stream and the product stream can be re-circulated through the ED stack and the FO module. In the iEDFO configuration the ED diluate is merged with the FO feed solution and the ED concentrate is merged with the FO draw solution, thus avoiding concentration limitations and fouling challenges in ED operation. The “diluate/feed” is passed through the ED membrane stack, then the output immediately flows to the feed side of the FO module. Similarly, the “concentrate/draw” solution follows the same flow pattern but in a different channel. The ED diluate is introduced directly into the FO module as the feed stream without first being collected in a holding container as in the two-stage configuration, and similarly the ED concentrate is introduced directly into the FO module as the draw stream without first being collected in a holding container as in the two-stage configuration. In certain embodiments, the applied voltage during the ED stage is 1 to 6 V/cell pair, more particularly 1 to 5 V/cell pair. In certain embodiments, the ED stack has a plurality of cell pairs, for example, 20 to 500 cell pairs.

Using synthetic digestate, iEDFO demonstrated superior performance compared to the two-stage configuration, achieving up to 54% shorter operation times and energy savings of up to 21%. These improvements are attributed to its higher current density and reduced ion back diffusion. Similar findings regarding shorter operation times (43%) and energy savings (25%) were observed in experiments with real liquid digestate. Additionally, the iEDFO configuration showed benefits, including (1) reducing membrane fouling by minimizing the competing effects between organic materials and charged nutrient ions in the ED diluate and (2) reducing the transport of organic contaminants across the anion exchange membrane into the ED concentrate product. FTIR, SEM-EDS and zeta potential analyses were conducted to analyze membrane surface, confirming the AEMs used in the iEDFO configuration experienced less fouling. Additionally, the analyses revealed that fouling occurred differently on the two sides of the membrane.

### Examples for EO-*FO Configuration

### Materials and Methods

### Liquid Anaerobic Digestate.

Raw liquid digestate samples were collected from Gresham Wastewater Treatment Plant (OR). To maintain uniformity in the liquid composition across experimental replicates, sampling was performed at approximately 1 PM every Tuesday during May 2023. Once the samples arrived at the laboratory, they were immediately subjected to a pretreatment process for solid-liquid separation. The pretreatment process consisted of following three steps. First, the digestate was centrifuged at 3,000 rpm for five minutes using an Allegra X-12R centrifuge system (Beckman Coulter, CA). Second, the supernatant was flocculated with 5 mL/L pDADMAC (10 wt %, Sigma-Aldrich, MO), followed by sedimentation. Third, the supernatant was filtered through a nylon capsule filter with a nominal pore size of 1 m to remove solids that could clog the ion-exchange membranes in the ED system. Table 3 presents the primary water quality parameters and macronutrient composition of filtrate that was used as the initial feed (diluate) in the ED treatment.

TABLE 3
Water Quality at Different Stages of ED-FO Treatment

| | | |
|---|---|---|
| | Final | |
| | Concentrate/ | |
| Initial | Initial | Final |
| Diluate | draw of FO | Draw |

Physiochemical properties

| | | | | |
|---|---|---|---|---|
| pH | | 8.03 ± 0.21 | 7.98 ± 0.06 | 8.30 ± 0.04 |
| Conduc- | (mS/cm) | 10.52 ± 0.16 | 33.03 ± 0.31 | 7.77 ± 0.07 |
| tivity | | | | |
| COD | (mg/L) | 704.9 ± 66.0 | 415.0 ± 8.2 | 48.6 ± 24.6 |
| TOC | (mg/L) | 623.8 ± 13.3 | 504.9 ± 9.9 | 111.4 ± 17.5 |
| UV₂₅₄ | (cm⁻¹) | 1.47 ± 0.06 | 0.77 ± 0.24 | 0.16 ± 0.06 |

Macronutrient composition

| | | | | |
|---|---|---|---|---|
| NH₄—N | (mg/L) | 1027.1 ± 29.9 | 3366.5 ± 45.6 | 715.2 ± 14.8 |
| K | (mg/L) | 636.1 ± 20.0 | 2658.3 ± 30.5 | 554.7 ± 19.7 |
| NO₃—N | (mg/L) | 140.2 ± 30.2 | 502.4 ± 120.7 | 107.4 ± 26.8 |
| PO₄—P | (mg/L) | 356.4 ± 15.1 | 1339.8 ± 71.4 | 286.6 ± 11.1 |

### Bench-Scale ED System and Operating Protocol

Well-controlled ED experiments were carried out using a laboratory-scale ED system supplied by PCCell GmbH (Heusweiler, Germany). The ED stack consisted of five cell pairs, including four PC MVK monovalent CEMs, two PC MTE cation exchange end membranes, and five standard PC SA AEMs (PCCell GmbH, Heusweiler, Germany) (see FIG. 2). Each membrane had an effective area of 64 cm². The CEMs contained sulfonate ion exchange functional groups, while the AEMs contained quaternary ammonium groups. Additional membrane properties are shown in Table 4.

TABLE 4
Major Properties of Ion-exchange Membranes

| | PC MVK | PC SA | PC MTE |
|---|---|---|---|
| Type | Monovalent CEM | Standard CEM | End CEM |
| Thickness (mm) | 0.1-0.11 | 0.1-0.11 | 0.22 |
| Electrical | 6 | 1.8 | 4.5 |
| resistance (Ω/cm²) | | | |
| Reinforcement | Polyester | Polyester | Polyethylene |

* Data presented in this table are from the manufacturers

The ED stack was assembled by alternately sandwiching the CEMs and AEMs between spacers, each with a thickness of 0.35 mm. To prevent initial high electrical resistance, a small amount (1.8 L) of 0.01 M K₂SO₄ solution was used as the initial concentrate. 9 L of pre-treated liquid digestate was used as the initial diluate. 0.25 M Na₂SO₄ was used for electrode rinsing solution (5 L). During ED experiments, the three solutions (concentrate, diluate, and electrode rinsing solution) were recirculated within their respective compartment at a flowrate of 25 L/min for the diluate and concentrate solutions and a flowrate of 150 L/min for the electrode rinsing solution. To mitigate fouling and scaling, the ED treatment was programmed to switch to electrodialysis reversal (EDR) mode for 1 minute after every 29 minutes of operation (30-minute cycle). The experiments were operated using a constant voltage of 5 V per pair and they were set to terminate once the electrical conductivity of the diluate reached 2.0 mS/cm, indicating an approximate 80% conductivity cutoff. The final concentrate stream and diluate stream were utilized in the FO process as the draw solution and feed water, respectively. To prevent the loss of ammonium through volatilization, both the diluate and concentrate compartments were sealed, preventing contact with the atmosphere.

ED performance was evaluated based on removal efficiency, recovery efficiency, and concentration factor (CF), expressed by the following equations:

$$Removal = \frac{{C}_{d , 0 , i} {V}_{d , 0} - {C}_{d , f , i} {V}_{d , f}}{{C}_{d , 0 , i} {V}_{d , 0}} \qquad ( 1 )$$

$$Recovery = \frac{{C}_{c , f , i} {V}_{c , f} - {C}_{c , 0 , i} {V}_{c , 0}}{{C}_{d , f , i} {V}_{d , f} - {C}_{d , 0 , i} {V}_{d , 0}} \qquad ( 2 )$$

$$CF = \frac{{C}_{c , f , i}}{{C}_{d , 0 , i}} \qquad ( 3 )$$

where C_{d,0,i} and C_{d,f,i} are the concentrations of ion i in the diluate stream at start and end of each experiment; V_{d,0} and V_{d,f} are the initial and final volume of diluate stream; C_{c,0,i} and C_{c,f,i} are the concentrations of ion i in the concentrate stream at start and end of each experiment; and V_{c,0} and V_{c,f} are the initial and final volume of concentrate stream. Due to osmosis and electro-osmosis phenomena, a small portion of water was transported from the diluate to the concentrate stream. As a result, the volume of the concentrate increased from 1.80 to 1.95 L by the end of the ED process. Therefore, removal and recovery efficiencies were calculated based on mass rather than concentration.

### FO System and Experimental Protocol.

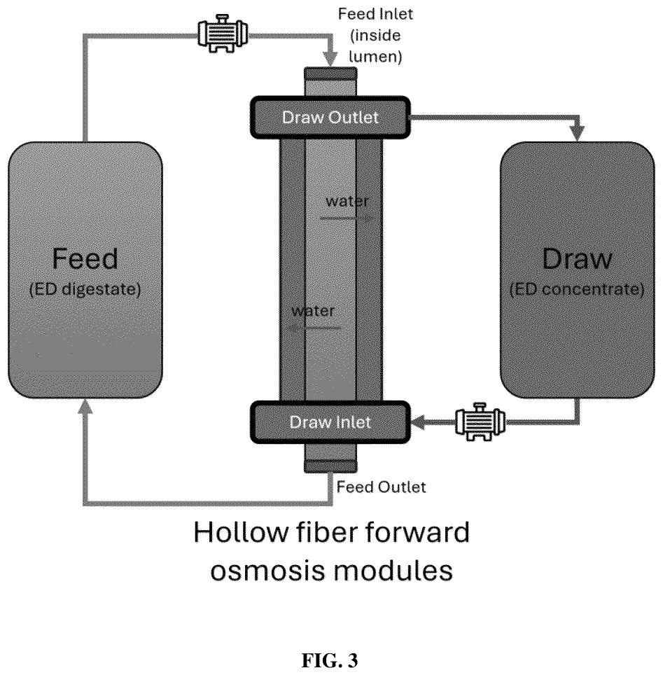

FO experiments were conducted to extract clean water from the ED diluate stream after treating liquid digestate using the ED concentrate stream as the draw solution. FIG. 3 presents a schematic diagram of the lab-scale FO system utilized in this study. In brief, the FO system comprised a feed tank, a draw solution tank, a FO membrane module, two variable-speed gear pumps (Cole-Parmer, IL) and a digital scale (Ohaus, NJ). A hollow fiber FO module HFFO2 (Aquaporin A/S, Lyngby, Denmark) with an effective surface area of 2.3 m² was used. This membrane comprises a polyamide thin film composite (TFC) selective layer with integrated aquaporin proteins. All FO experiments were operated with the lumen-side selective layer facing the feed solution due to lower fouling tendency in this orientation. During the experiments, the feed and draw solutions were recirculated at rates of 50 L/hour and 25 L/hour, respectively, using two gear pumps operating in a counter-current mode. The draw solution tank was placed on a digital scale and weight changes over time were monitored to determine permeate water flux. The FO experiments were stopped when no further permeate flux was observed, indicating osmotic equilibrium. At the end of each experiment, water recovery rate (r) was calculated using:

$$r = \frac{{V}_{dr , f} - {V}_{dr , 0}}{{V}_{f , 0}} \qquad ( 4 )$$

where V_{dr,0} and V_{f,0} are the initial volume of feed and draw solutions, and V_{dr,f} is the final draw solution. The loss of nutrients in the draw solution tank during the FO operation was determined by a mass balance calculation. The final nutrient solution in the draw tank was used for hydroponic testing. At the end of FO experiments, both feed tank and draw solution tank were emptied and the membrane module was rinsed with deionized water for 15 minutes per channel (feed and draw).

### Energy Consumption.

The overall energy consumption within the ED-FO system comprises three main components: electrochemical energy in ED, pumping energy in ED and pumping energy in FO. In the ED treatment, the pumping energy is notably lower by at least an order of magnitude compared to the electrochemical energy, as highlighted in previous research. Thus, in ED analysis, we focused solely on the electrochemical energy component which is expressed by

$${E}_{i} = \frac{{\int }_{0}^{t} UI ( t ) dt}{{C}_{c , f , i} {V}_{c , f} - {C}_{c , 0 , i} {V}_{c , 0}} \times \frac{{Z}_{i} F ( {V}_{d , 0} \times {C}_{d , 0 , i} - {V}_{d , f} \times {C}_{d , f , i} )}{\int I ( t ) dt \times N} \qquad ( 5 )$$

where Zᵢ is ionic charge of ion i, F is the Faraday constant, I is the real-time monitored electric current, N is number of cell pairs in the membrane stack, and U is the applied potential on the membrane stack.
The energy consumption in FO was calculated by

$${E}_{FO} = \frac{Q \times H \times g \times ρ}{{V}_{{H}_{2} O}} \qquad ( 6 )$$

where Q is the total flowrate of solution in the feed and draw channels, H is the headloss observed in the system, g is the gravitational constant, p is the solution density and V_{H}_{₂}_{O} is the volume of clean water recovered at the end of FO treatment.

### Analytical Methods.

Each experiment was conducted in triplicate, and data were expressed as the average of the replicates along with their corresponding standard deviation. Water samples were collected and analyzed for pH, electrical conductivity (EC), ARGs, and the concentrations of macronutrients, heavy metals, and organic compounds. The pH and EC were measured using an IDS 4120 pH electrode and an IDS4310-3 conductivity probe (YSI, OH). Concentrations of NH₄⁺, NO₃⁻ and K⁺ were measured using an IMACIMUS multi-ion analyzer (NT Sensors, El Catllar, Spain), and PO₄—P was determined using the molybdovanadate spectrophotometric method. Heavy metals, including Fe, Ni, As, Sb and Pb, were determined by inductively coupled plasma coupled mass spectroscopy (iCAP RQ ICP-MS, Thermo Scientific, OR). Total organic carbon (TOC) was measured using Hach TOC test kits. UV₂₅₄ absorbance, which serves as an indicator of the presence of organic compounds, especially those containing aromatic rings, was determined using a UV-vis spectrophotometer (Orion AquaMate 8000, Thermo Fisher Scientific Inc., WA).

For non-target analysis, triplicate samples were enriched with solid-phase extraction (SPE), and then analyzed on an ultra-high performance liquid chromatography high resolution mass spectrometry (UHPLC-HRMS) system. Chromatographic separation of organic compounds was performed using an XBridge C18 column (2.1×50 mm, 3.5 μm, Waters, Milford, MA) with a Waters Cartridge Guard Column (XBridge BEH, C18, 3.5 μm, Waters, Milford, MA) in an UHPLC (Sciex ExionLC AD) system, followed by ionization and mass analysis using a HRMS (Sciex ZenoTOF 7600). Samples were run in data dependent acquisition (DDA) in both positive and negative electrospray ionization modes (ESI). Both MS1 and MS2 spectra were acquired for masses ranging from m/z 70 to 1000 Da for all samples, including extraction blanks, instrument blanks and pooled quality control samples.

For ARG analysis, samples were thoroughly mixed and filter-concentrated through 0.45-μm filter paper. The filter paper was stored in 1 mL of 50% ethanol at −20° C. until further processing. DNA was extracted using the FastDNA Spin Kit for soil (MP Biomedicals, Solon, OH). The stored filter paper was removed from 50% ethanol, torn into small pieces, and placed in a lysing tube. The remaining ethanol was then centrifuged at 5,000×g for 10 minutes; supernatant was discarded. The pellet was resuspended using sodium phosphate buffer from the kit and transferred to the lysing tube. The remaining DNA extraction steps were followed using the manufacturer's protocol. DNA concentration and purity were evaluated using a NanoDrop™ One© Micro UV-VIS Spectrophotometer (ThermoFisher Scientific, Waltham, MA). As ARG target, we selected blaCTX-M gene as it confers resistance to extended-spectrum beta-lactamases (ESBLs). Beta-lactams are last-resort antibiotics and ESBL-associated genes confer resistance to a broad spectrum of the most commonly prescribed antibiotic class: beta-lactams, including penicillins and 1^{st} to 3^{rd} generation cephalosporins. The U.S. Centers for Disease Control and Prevention has distinguished ESBL-producing Enterobacterales as one of the most serious threats facing humanity's efforts against antimicrobial resistance. blaCTX-M gene was quantified via quantitative PCR (qPCR) using a CFX Connect™ Real-Time PCR Detection System and analyzed using the CFX Manager™ Software 3.1 (Bio-Rad, Hercules, CA).

### Plant Growth Assessments

Nutrient water recovered through the ED-FO process was used to grow plants with hydroponic growing systems (Aerogarden Harvest, CA). Two commonly consumed leafy vegetables, kale (Brassica oleracea) and lettuce (Lactuca sativa) were tested with three different treatments, whereby the plants were grown with (1) pre-treated liquid digestate, (2) final draw solution obtained after FO treatment, or (3) DI water used as a control. Before initiating the growth tests, both the final FO draw solution and pre-treated liquid digestate were diluted to achieve a total nitrogen concentration of 100 mg/L, which is the same level found in half-strength Hoagland's solution (a standard hydroponic nutrient solution designed for lettuce).

Three plants of both crops were cultivated in nine growing systems, for a total of nine replicates per water treatment. In each case, seeds were first sown in grow sponges made from Canadian sphagnum peat and irrigated with DI water for 7 days for germination. Afterwards, the seedlings were grown with the three aforementioned treatments for a duration of 5 weeks, during which time the nutrient solutions were replenished weekly. At the end of the experiment, the plants were harvested from each system and immediately weighed to calculate mean fresh weight in each treatment. Subsequently, the plants were oven-dried at 65° C. to determine the dry weight. The obtained results were analyzed by one-way ANOVA to reveal any differences between the treatment methods and crop types.

### Electrodialysis of Liquid Digestate to Recover Nutrient Ions.

ED experiments were conducted using pre-treated anaerobic effluent as the initial diluate and 0.01 M K₂SO₄ solution as the initial concentrate stream. The experiments were operated until ˜80% of conductivity cutoff was reached. FIG. 4 illustrates the variations of EC in each stream and the current density across the ED stack over time. All experiments were conducted in triplicates, and the experimental results were highly reproducible. The data displayed in FIG. 2 are derived from one of the triplicates. With an electric potential being applied, charged ions continuously migrated from the diluate stream into the concentrate stream. Electric conductivity of the diluate stream decreased from 10.52±0.16 mS/cm to 1.92±0.02 mS/cm, while that in the concentrate stream increased from 2.39±0.06 mS/cm to 33.03±0.31 mS/cm. Clearly, at the end of ED treatment, conductivity of the concentrate stream was significantly higher than that found in the diluate stream. Thus, there was a huge osmotic pressure difference between the concentrate stream and diluate stream, making them ideal draw and feed solutions, respectively, in the following FO treatment.

The peaks observed in the current density curve indicated the occurrence of EDR when the same applied potential was reversed in polarity. Implementation of EDR resulted in membrane fouling/scaling mitigation, shorter operating time, and thus reduced energy consumption. For instance, it took approximately 4.1 hours to reach ˜80% conductivity cutoff with EDR, whereas it took 20.8 hours without EDR. Between each EDR, current density declined gradually at a constantly applied potential of 5 V per pair. This decline in current density during ED treatment of real anaerobic effluent was attributed to (1) continuous dilution of the feed water flowing into the diluate compartment and (2) membrane fouling and scaling. According to a resistance-in-series model, electrical resistance of the ED stack is determined by the sum of the resistance of the ion-exchange membranes resistance and resistance of the solution flowing in the diluate/concentrate channels. Overtime, ion depletion in the feed/diluate stream gradually increased the electrical resistance of the diluate stream and the overall solution resistance. Moreover, obvious changes were observed on the membrane surface after the treatment of real anaerobic effluent. Electrostatic attraction between negatively charged organics and positively charged AEM resulted in organic compounds and microorganisms moving toward the AEM under the electric field, forming a brownish cake layer on the membrane surface. CEMs were more prone to inorganic scaling. White mineral scaling was observed on the CEM surface at the end of each experiment. The fouling on AEM and scaling on CEM increased the membrane resistance and limited the number of free ion-exchange sites within the membranes. Consequently, enhanced solution resistance and membrane resistance led to a reduction in current density and ED efficiency over time.

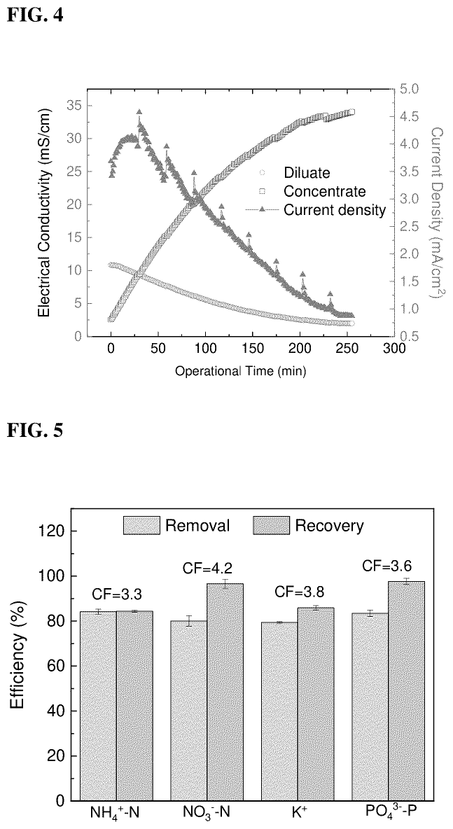

FIG. 5 presents the removal efficiency, recovery efficiency, and concentration factor of macronutrient ions. As expected, the concentration of NH₄—N decreased from 1027±30 mg/L to 165±17 mg/L in the diluate stream, while it increased to 3366±46 mg/L in the concentrate stream, corresponding to a concentrating factor of 3.3 and recovery efficiency of 84.4%. Similarly, concentrations of PO₄—P, K, and NO₃—N in the concentrate stream at the end of ED treatment increased to 1340±71 mg/L, 2658±30 mg/L, and 519±124 mg/L, respectively. The average concentration factors achieved for PO₄—P, K and NO₃—N in all three replicates were 3.8, 4.2, and 3.6, respectively, and the recovery efficiency was 97.6%, 85.8%, and 96.6%, respectively. The concentration factor can be further improved by choosing an appropriate diluate/concentrate volume ratio. The cationic nutrients, NH₄—N and K, were not recovered to the same extent as anionic nutrients, PO₄—P and NO₃—N. This phenomenon can be attributed to the configuration of the ED stack where cation-exchange end membranes were placed adjacent to the electrode compartments. Consequently, cations could transport into the electrode rinsing solution, while anions remained confined in the diluate and concentration streams. However, loss of NH₄—N and K in the electrode rinsing compartment is considered negligible in large-scale ED operations, where more repeating units are installed in a single ED stack. Additionally, it was found that there was a strong similarity between reduction of conductivity in the diluate stream (81.7%) and removal efficiency of nutrient ions (79.4-83.4%). This similarity suggests that changes in nutrient concentration closely correlate with changes in conductivity. Therefore, conductivity could serve as a quick indicator to evaluate the desalination performance of the ED process. FO Performance: Water Flux, Water Recovery, and Final NPK Concentration Bench-scale FO experiments were conducted to extract clean water from the desalinated liquid digestate (final ED diluate stream) using final ED concentrate stream as draw solution. The FO performance was evaluated based on water flux, water recovery, and nutrient concentration in the diluted draw solution. FIG. 6 presents the water flux and accumulated permeate volume during FO operation. During the 110-minute operation, water flux decreased significantly from an initial value of 7.78±1.27 LMH to 0.06±0.01 LMH. The decline in water flux can be attributed to (1) continuous dilution of draw solution and thereby reduced osmotic pressure driving force across the FO membrane and (2) membrane fouling which increased the resistance to water permeation through the membrane. Highly reproducible flux curves from triplicate experiments clearly indicated that almost all deposited foulants were removed by simple hydraulic flushing. At the end of each run, a total of 5886±76 mL of water was extracted, rendering a water recovery of 74.5%.

In addition to water migration from feed to draw solution, ions could back diffuse from the draw solution to the feed, resulting in a loss of nutrients. A simple mass balance calculation of nutrient ions showed negligible loss of NH₄—N(0.4%), PO₄—P (0.6%), K (4.1%), and NO₃—N (0.2%) in the draw solution of the present study. The results presented in Table 3 indicate that nutrient concentrations in the final diluted draw solution were much higher than the standards for hydroponics. Therefore, the final FO draw solution had to be diluted before it could be used to grow lettuce or kale in the growth trial.

Transport of Organics, Heavy Metals, and ARGs during ED-FO.

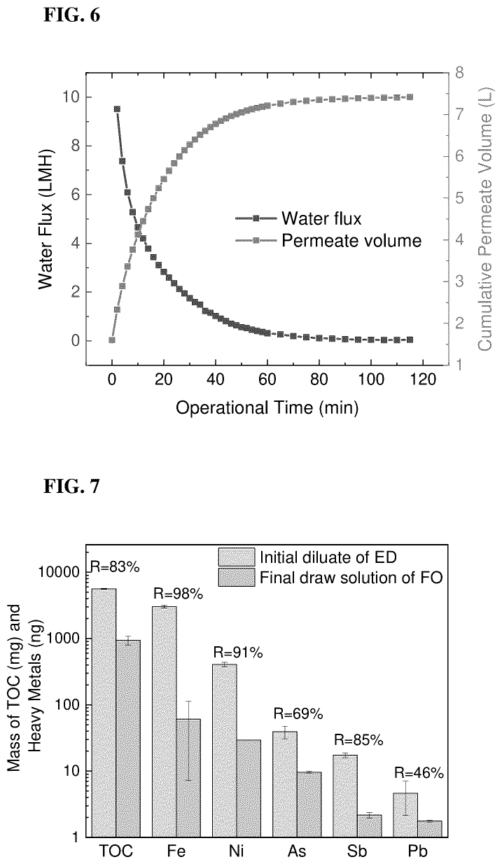

Direct application of nutrient-rich anaerobic effluent is generally unsuitable for plant production due to the presence of various detrimental components, such as organic pollutants, heavy metals, and pathogenic organisms. Elevated levels of organics in the waste stream could hinder plant growth by introducing phytotoxic compounds. This issue could be exacerbated by a high biological oxygen demand within the root zone, triggered by excessive microbial activity, depleting dissolved oxygen and asphyxiating the plant roots. In the ED process, electrostatic and hydrophobic interactions between compounds and IEMs control the transport of organic compounds. FIG. 7 presents the amount of TOC in the initial diluate before undergoing ED treatment and the final product after FO treatment. The application of the ED-FO treatment resulted in removal of 83.3±2.3% of TOC from the ultimately recovered nutrient-rich water. The significant reduction achieved by the ED-FO treatment indicates that this transformative process renders the resulting product safer and more appealing for agricultural use.

Furthermore, a brief examination of the variation in ARG content revealed a reduction of 2.2 log gene copies/mL of blaCTX-M. This observation is relatively straightforward, because the average molecular weight of blaCTX-M is ˜23 kDa⁶⁶, which is much larger than typical organic matter that can migrate across ion-exchange membranes. Indeed, it was found that only low molecular weight organic matter (<300 Da), mostly acidic, can transport through AEMs to a noticeable degree, while other studies have shown a reverse correlation between the molecular weight of organic compounds and its transportability across ion-exchange membranes.

In addition to organic pollutants, anaerobic effluent contains heavy metals. When applied to farmlands without appropriate treatment, these heavy metals can accumulate in the soil, posing risks of entering the human food chain and causing chronic health issues. Monovalent CEMs in the ED were selected in these experiments. The purpose was to capture multivalent cations, which include heavy metals, within the diluate compartment. This approach enabled obtaining liquid fertilizers in the concentrate that were rich in essential plant nutrients and devoid of heavy metals. As presented in FIG. 7, following the ED-FO treatment, the amount of heavy metals in the final product water was reduced by 98% for Fe, 93% for Ni, 75% for As, 88% for Sb, and 62% for Pb. While elimination of As and Pb were relatively less in comparison to other heavy metals, their concentrations in the final product water satisfy the standards set by the Food and Agriculture Organization. Consequently, the recovered nutrient-rich water from the process was deemed suitable for irrigation purposes.

### Hydroponic Growth of Lettuce and Kale.

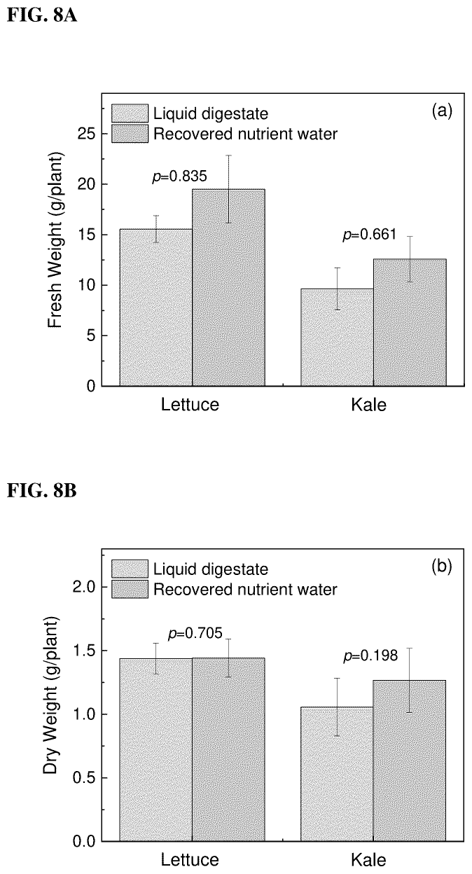

The growth performance of lettuce and kale was tested in hydroponic systems filled with (1) liquid digestate, (2) nutrient water recovered from the ED-FO treatment, or (3) DI water. None of the plants grown with DI water showed any growth, and therefore, only weights of plants grown with liquid digestate and recovered nutrient water are presented in FIG. 8. After 5 weeks, there was no difference in the fresh or dry weights of plants grown with liquid digestate or nutrient water recovered via ED-FO treatment. This observation was primarily attributed to adjusted nitrogen content in the initial hydroponic solutions, a major factor influencing the biomass of the harvested vegetables. While the ED-FO treatment did not show a noticeable improvement in the development of these leafy greens, we expect that significant removal of hazardous organics and heavy metals from the liquid digestate (FIG. 7) will enhance crop health and food safety over the long run.

### Energy Consumption and Implications.

Energy consumption of the ED-FO system was calculated, followed by a preliminary cost-benefit evaluation. In the ED process, a constant voltage of 25 V was applied. Energy consumption across the three replicate experiments yielded values of 16.32±1.39 kWh/kg for nitrogen, 5.86±0.55 kWh/kg for potassium, and 5.16±0.48 kWh/kg for phosphorus. While there are several well-developed and competing techniques for nutrient recovery, they still face significant challenges. For instance, methods like ion exchange, adsorption, ammonia stripping, and chemical precipitation are commonly employed. However, these methods require continuous consumption of chemicals (i.e., pH control, magnesium/calcium addition, or acids for stripping), which pose negative impacts on the environment. Other competing pressure-driven membrane-based processes like nanofiltration and RO are susceptible to fouling due to the elevated solid content of the digestate, even when considering only its liquid fraction. In contrast, ED effectively mitigates fouling concerns owing to its electrophysical nature, which operates differently from typical size exclusion mechanisms in pressure-driven membrane processes.

In addition to nutrients, the hybrid ED-FO process recovers high-quality water for crop irrigation. While energy consumption for treatment of anaerobic effluent by the ED-FO hybrid system was 27.8 kWh/m³, actual energy for water recovery via the FO process was only 3 Wh/m³. The hybrid ED-FO treatment process not only transforms waste products into valuable assets but also diminishes environmental impacts, thus promoting a circular economy.

### Examples for iEDFO Configuration

### Materials and Methods

### Liquid Anaerobic Digestate

Both synthetic and real anaerobic digestate were used as the feed water of ED. The ED optimization experiments were first carried out on synthetic water, which contained ammonium phosphate dibasic to represent the primary nutrient component found in actual digestate. The composition of the synthetic digestate consisted of 8 g of (NH₄)₂HPO₄ and 0.2 mL of 8.7% H₃PO₄ per liter. All the salts in this investigation were analytical grade, and the salt solutions were made by deionized water. Real liquid digestate samples were collected from Gresham Wastewater Treatment Plant (OR). Prior to being fed to ED, the raw digestate was pretreated to remove solids that could clog the membranes. The solid-liquid separation process utilized a Lakos ILB-0050 centrifugal separator (PRM Filtration, NC), followed by successive bag filtering treatments (PRM Filtration, NC), which involved the use of filters with progressively decreasing nominal pore sizes aimed at removing particles larger than 1 μm.

### ED Optimization

All ED experiments were carried out using a bench-scale ED system supplied by PCCell GmbH (Heusweiler, Germany). In brief, the ED stack contained two titanium electrodes coated with a platinum/iridium mixed metal oxide coating for the cathode/anode, respectively. Five cell pairs were formed with four PC MVK monovalent CEMs, two PC MTE cation exchange end membranes, and five standard PC SA AEMs (PCCell GmbH, Heusweiler, Germany). AEMs and CEMs were alternately arranged and separated by 0.5 mm silicone/polyethylene spacers, forming the dilute, concentrate and electrode compartments. The aforementioned synthetic digestate was used in the ED optimization experiments as initial dilute and concentrate. The effects of different operating variables, including the applied potential (2-6 V/cell pair), flowrate (10-30 L/h), cut-off point (85-99%), and volumetric ratio of diluate to concentrate (2.5-12.5) on the ED performance (e.g., ion transport rate, energy consumption, and concentration factor) were evaluated to optimize the ED treatment process.

In the present study, two configurations of the ED-FO treatment process (FIG. 9) were established in the laboratory and compared. The two configurations included (1) ED followed by FO (ED→FO), and (2) integrated ED and FO operation (iEDFO). The latter configuration can overcome the inherent limitations associated with the ED process and thus offer significant advantages due to its (1) enhanced recovery efficiency, (2) reduced energy consumption, and (3) mitigated membrane fouling. The differences in nutrient recovery, energy efficiency, and membrane fouling between the two configurations were assessed. The optimal operating conditions (e.g., voltage and flow rate) determined in the preceding section for the ED process were utilized in these comparative experiments.

In the ED→FO mode (FIG. 9A), ED system was initially used to recover charged nutrient species from digestate. The final diluate and concentration streams resulting from the ED treatment were then fed into the feed compartment and draw compartment, respectively, in the FO system. During FO treatment, two gear pumps were used to recirculate the feed (ED diluate) and draw solutions (ED concentrate). It is the natural tendency for clean water to be “pumped” out of the ED diluate and pass into the highly concentrated nutrient solution through the FO membrane; thus, clean water is recovered. In the iEDFO mode (FIG. 9B), only two pumps were utilized instead of the usual four (in the ED→FO mode). One pump circulated the digestate between the dilute compartment of the ED stack and feed compartment of the FO module. The second pump circulated the nutrient water between the concentrate compartment of the ED stack and draw compartment of the FO module. This allowed for the simultaneous processing of nutrients and clean water recovery.

### Analysis of Efficiency and Energy Consumption

Each experiment was conducted in triplicate, and the data presented in the tables represent the average of these replicates, along with their corresponding standard deviations. The repeated experiments consistently showed minimal variation, indicated by the small standard deviations. Therefore, graphs in this study depict robust experimental results without the addition of error bars, as they would be too small to visualize effectively.

For the actual liquid digestate, water samples were collected and analyzed for organic content. Chemical oxygen demand (COD) was determined for unfiltered samples using Hach COD test kits. Dissolved organic carbon (DOC) was measured in samples filtered through a 0.45 micron filter before analysis using Hach TOC test kits. UV254 absorbance, which indicates the presence of organic compounds, particularly those containing aromatic rings, was determined using a UV-vis spectrophotometer (Orion AquaMate 8000, Thermo Fisher Scientific Inc., WA).

The ED performance was assessed under different operating conditions in terms of current density, transport rate, stripping efficiency, concentration factor, and energy consumption, expressed by the following equations.

$$Current density = I / S \qquad ( 1 )$$

where I is the real-time monitored electric current through the ED stack, S is the membrane surface area.

$$Transport rate = \frac{{C}_{d , 0 , i} {V}_{d , 0} - {C}_{d , f , i} {V}_{d , f}}{t} \qquad ( 2 )$$

$$Stripping efficiency = \frac{{C}_{d , 0 , i} {V}_{d , 0} - {C}_{d , f , i} {V}_{d , f}}{{C}_{d , 0 , i} {V}_{d , 0}} \qquad ( 3 )$$

$$Concentration factor = \frac{{C}_{c , f , i}}{{C}_{d , 0 , i}} \qquad ( 4 )$$

where C_{d,0,i} and C_{d,f,i} are the concentrations of ion i in the diluate stream at start and end of each experiment; V_{d,0} and V_{d,f} are the initial and final volume of diluate stream; C_{c,0,i} and C_{c,f,i} are the concentrations of ion i in the concentrate stream at start and end of each experiment; V_{c,0} and V_{c,f} are the initial and final volume of concentrate stream; and t is the total operation time. Due to osmosis and electro-osmosis phenomena a small portion of water was transported from the diluate to the concentrate stream.

In the ED treatment, the pumping energy is notably lower by at least an order of magnitude compared to the electrochemical energy, as highlighted in previous research^{19, 17,25}. Thus, in ED analysis, we focused solely on the electrochemical energy component which is expressed by

$${E}_{ED} = \frac{{\int }_{0}^{t} UI ( t ) dt}{{C}_{c , f , i} {V}_{c , f} - {C}_{c , 0 , i} {V}_{c , 0}} \times \frac{{Z}_{i} F ( {V}_{d , 0} \times {C}_{d , 0 , i} - {V}_{d , f} \times {C}_{d , f , i} )}{\int I ( t ) dt \times N} \qquad ( 5 )$$

where Zᵢ is ionic charge of ion i, F is the Faraday constant, N is number of cell pairs in the membrane stack, and U is the applied potential on the membrane stack.

The FO performance was evaluated based on water recovery rate (r) and energy consumption (E_{FO}), expressed by the following equations:

$$r = \frac{{V}_{dr , f} - {V}_{dr , 0}}{{V}_{f , 0}} \qquad ( 6 )$$

where V_{dr,0} and V_{f,0} are the initial volume of feed and draw solutions, and V_{dr,f} is the final draw solution.

$${E}_{FO} = \frac{Q \times H \times g \times ρ}{{V}_{{H}_{2} O}} \qquad ( 7 )$$

where Q is the total flowrate of solution in the feed and draw channels, H is the headloss observed in the system, g is the gravitational constant, p is the solution density and V_{H}_{₂}_{O} is the volume of clean water recovered at the end of FO treatment.

### Membrane Fouling Characterization

At the conclusion of each ED experiment, a total of 4 fouled monovalent CEMs and 5 fouled standard AEMs were collected from the ED stack. These membranes underwent immediate gentle rinsing under deionized water to remove any loosely attached foulants on their surfaces. Two of the membrane pieces were then completely dried in an oven at 50° C. overnight for subsequent scanning electron microscopy coupled with energy dispersive X-ray spectroscopy (SEM-EDS) and Fourier-transform infrared spectroscopy (FTIR) analyses. The remaining membrane pieces were stored in deionized water at 4° C. before being subjected to zeta potential and ion exchange capacity (IEC) analyses. SEM-EDS was utilized to characterize the chemical deposits on the membrane. Prior to SEM-EDS analysis, membrane samples were cut into 4 mm diameter circles, dried overnight, and then coated with a thin layer of gold and palladium (Au/Pd) using a sputter coater. SEM images were captured at 5 kV with varying magnifications using the FEI Quanta 3D Dual Beam SEM (Thermo Fisher Scientific Inc., WA), equipped with a focused ion beam. EDS analysis was conducted on a sample area magnified to 1000× using an EDAX “digi view” electron backscattered diffraction system. In addition, the surfaces of pristine and fouled membranes were analyzed by FTIR to characterize the fouling caused by organic matter. FTIR was performed on a Nicolet iS50 FTIR spectrometer equipped with an ATR element (42° single-reflection germanium Seagull™ variable angle reflection element). Membrane surface zeta potential was determined from streaming potential measurement using an electrokinetic analyzer SurPass 3 (Anton Paar, VA). The measurement was performed at 10 mM KCl solution with pH ranging from 6 to 9.

The extent of IEM fouling was further investigated by measuring the changes in IEC, which represents the total number of exchangeable ions that the membrane can hold. IEC was determined according to a previous method. For CEM analysis, membrane pieces were soaked in a 1 M HCl solution for 1 hour under non-abrasive agitation with an orbital shaker. Subsequently, the CEM pieces were rinsed with deionized water and soaked for 2 hours in a basic solution prepared by mixing 20 mL of 0.1 M NaOH and 230 mL of 0.1 M NaCl. 25 mL of the remaining basic solution was then titrated with 0.02 M HCl. The IEC of CEM (mole of equivalent/kg of dry membrane) was calculated as follows:

$${IEC}_{CEM} = 0.2 \frac{{V}_{2} - {V}_{1}}{{m}_{CEM}} \qquad ( 8 )$$

where V₂ is the volume of 0.02 M HCl required to titrate the control solution, V₁ is the volume of 0.02 M HCl required to titrate the base solution remaining after exchange with the membrane pieces and m_{CEM} is the dry mass of CEM pieces.

For AEM analysis, membrane pieces were soaked in a 0.1 M HCl solution for 1 hour with agitation. The AEM pieces were then rinsed with deionized water and soaked for 12 h in 250 ml of 1 M HNO₃ solution. The concentration of Cl⁻ released to the acid solution was determined by a chloride selective electrode (NT Sensors, El Catllar, Spain). The IEC of AEM (mole of equivalent/kg of dry membrane) was calculated as follows:

$${IEC}_{AEM} = \frac{{n}_{Cl}}{{m}_{AEM}} \qquad ( 9 )$$

where n_{Cl} is the number of moles of chloride ions released in the acidic solution remaining after the exchange with the membrane pieces and m_{AEM} is the dry mass of AEM pieces.

### Results and Discussion

### Electrodialysis Optimization

### Effects of Voltages and Flow Rates on ED Performance

A critical factor influencing the concentration performance of ED process is the applied voltage. It directly affects the current density, a parameter governing the migration of charged nutrient species and energy consumption. Initially, current density increases linearly with low voltage. However, as voltage rises further, the rate of increase slows and reaches a critical threshold known as the limiting current density (LCD). Beyond the LCD, water splitting occurs, consuming energy without significantly contributing to nutrient recovery. Therefore, operating below the LCD is essential for optimizing ED performance. In this study, the linear relationship between current density and applied voltage confirms that all the experiments were conducted below LCD.

The change in ionic transport rate and specific energy consumption under different operating voltages are shown in FIG. 10A. The ionic transport rate increased with higher operating voltage due to the stronger driving force for ion migration according to the Nernst-Planck equation. However, the specific energy consumption, defined as the energy consumed to migrate a unit amount of ammonium phosphate dibasic, remained nearly parallel to the ionic transport rate as the voltage increased. This highlights the trade-off: higher voltages expedite the treatment process but come at the cost of greater energy inefficiency. Additionally, the pH, monitored hourly during the ED process, did not show any disruptive changes, further confirming that the ED process was operating below its LCD limit. Overall, 20 V was selected as the optimal voltage, offering a balanced trade-off between specific energy consumption and ionic transport rate.

FIG. 10B illustrates the impact of water flowrate on both ionic transport rate and specific energy consumption. How rate did not significantly affect specific energy consumption. Increasing the flow rate from 10 to 20 L/h resulted in a slight (4%) decrease in specific energy consumption, indicating more efficient ionic transport at higher flow rates. In contrast, the ionic transport rate of the ED process increased rapidly from 1.9 mmol/min to 2.8 mmol/min as the flow rate rose from 10 to 20 L/h, then stabilized with further increases in flow rate. This initial enhancement is likely due to improved mass transfer and reduced concentration polarization near the membrane surface. However, further increasing the flow rate reduces the hydraulic retention time of ions in the ED stack, diminishing the degree of ion migration through the membrane. Considering that increasing the flow rate beyond 20 L/h would raise total energy consumption without significant time savings and could potentially damage the membrane due to high pressure, 20 L/h was chosen as the optimal flow rate for the ED process.

Limited Ion Stripping Efficiency and Concentration Factor While ED can effectively strip ions from the dilute stream and enrich ions in the concentrate stream, its stripping efficiency and thus nutrient recovery efficiency are limited. As ions transport from the diluate stream to the concentrate stream in the ED concentration process, the growing ion concentration differences between the diluate and concentrate channels lead to an increased osmotic pressure differential across the membranes, which would be further worsen by concentration polarization. This increased osmotic pressure works against the applied electric potential, reducing the driving force for ion migration and lowering current efficiencies.

As displayed in FIG. 11, specific energy consumption slightly increased with stripping efficiency until 90% of the ions were removed from the diluate stream and transferred to the concentrate stream. Once the stripping efficiency surpassed 90%, there was a significant jump in energy consumption. This is because, at very high stripping efficiency (e.g., 99%), the greatly enhanced diluate resistance due to ion depletion, concentration polarization, and the osmotic pressure difference across the membranes significantly reduce the driving force for ion migration from the diluate to the concentrate.

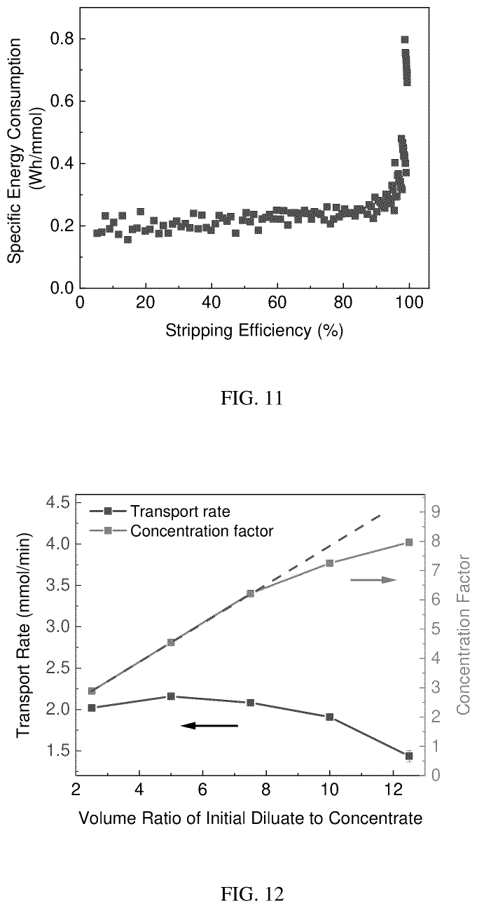

In the ED concentration process, the initial volume ratio of the diluate to concentrate is an important factor that can affect both the ion transport rate and water transport by osmosis, thereby influencing the maximum achievable concentration factor. As shown in FIG. 12, a higher initial volume ratio led to a greater final concentration factor. At a volume ratio of 7.5, (NH₄)₂HPO₄ could be concentrated to 6.2 times of the initial feed concentration. However, as the volume ratio increased from 7.5 to 12.5, the rate of increase in the concentration factor slowed down. This occurs because while more ions are available for migration with a larger diluate volume (greater volume ratio), the growing concentration difference between compartments also promotes (1) ion back diffusion, as evidenced by the decreasing ionic transport rate, and (2) water transport from diluate to concentrate chamber driven by the increased osmotic pressure difference, ultimately limiting the achievable concentration of the target nutrient species in the final concentrate solution. Such ED limitations will also restrict the maximum achievable water recovery in Stage 2 FO treatment (FIG. 9A). In this study, we proposed a novel and simple iEDFO process. By integrating ED and FO simultaneously, the limitations associated with ED (such as the increased osmotic pressure differentials across the membranes as the ED process progresses) can be addressed.

Integrating ED and FO to Overcome ED Limitations: Comparison Between iEDFO and ED

In the design shown in FIG. 9A the hybrid ED-FO process consisted of two stages: ED to recover charged nutrient species followed by FO to extract clean water. However, the inherent limitations of ED prevent us from achieving maximum nutrient and water recovery, which diminishes the incentive for its adoption. In this study, we hypothesized that simultaneous operation of the ED and FO processes could mitigate these limitations. By merging the ED diluate with the FO feed solution, and the ED concentrate with the FO draw solution (FIG. 9B), we aim to facilitate concurrent nutrient and water recovery. As the ED process progresses, charged nutrient species from the diluate (anaerobic digestate) will accumulate in the combined concentrate/draw stream, eventually reaching a concentration that generates a sufficient osmotic pressure difference across the FO membrane. This will trigger water movement from the combined diluate/feed side to the concentrate/draw side, along with the migration of charged nutrient species. The process will reach a steady state when a stable osmotic pressure difference is established between the diluate and concentrate streams, balancing the water flux from the diluate to the concentrate with the ionic flux in the same direction. Therefore, the iEDFO configuration can maintain a stable current density throughout the simultaneous nutrient and water recovery process. In this session, the advantages of the iEDFO configuration were confirmed by comparing it with conventional ED for nutrient recovery applied in the ED→FO configuration.

First, building on the optimal operating conditions identified above, experiments were conducted to compare the performance of the iEDFO configuration with the original two-stage ED→FO process. Synthetic anaerobic digestate was used as the feed solution in two scenarios: achieving 90% and 99% stripping efficiency for nutrient ions. FIG. 13 illustrates the changes in electrical conductivity and current density in the ED stack over time, clearly supporting our hypothesis. In synthetic anaerobic digestate, changes in nutrient ion concentration correlated closely with changes in conductivity. As expected, when an electric potential was applied, charged ions continuously migrated from the diluate stream to the concentrate stream. At the end of conventional ED treatment with 90% stripping efficiency (FIG. 13A), the conductivity in the diluate stream decreased from 9.2 mS/cm to 1.5 mS/cm (yellow), while in the concentrate stream, it increased from 9.2 mS/cm to 40.4 mS/cm (green). Current density continuously decreased during the experiment due to the increasing electrical resistance of the diluate stream (pink). At the end of ED treatment, the significantly higher ion concentration in the concentrate stream compared to the diluate stream is beneficial for water transport and recovery in the subsequent FO treatment, which is driven by the large osmotic pressure difference between the two streams (FIG. 9A). However, a large concentration difference could hinder the migration of ions in the ED process and reduce the efficiency of the overall process.

Unlike conventional ED, during iEDFO process, the concentrate conductivity increased slowly and stabilized at 9.5 mS/cm (blue), while the diluate conductivity decreased slowly and stabilized at 7.7 mS/cm (grey) when the target stripping efficiency of 90% was achieved (FIG. 13A). Such slight changes in ion concentrations are favorable for overcoming the inherent limitations of conventional ED treatment. First, the slightly higher ion concentration in the concentrate/draw stream compared to the dilute/feed stream drives continuous water movement and recovery. Importantly, this difference is not significant enough to cause significant concentration polarization and hinder ion migration. Second, the relatively stable ion concentration in the dilute stream maintains a much higher current density (red) compared to conventional ED (pink). Theoretically, a higher current density accelerates ion migration through membranes, leading to shorter operating times. Experimental results show the iEDFO process achieved 90% stripping efficiency in just 371 minutes, a significant 28.3% reduction in time compared to the 518 minutes required by the conventional ED process (FIG. 13A). This advantage is even more pronounced at 99% stripping efficiency, where iEDFO requires 375 minutes, a 53.9% reduction compared to conventional ED process (FIG. 13B). Upon further analysis of energy consumption, the iEDFO configuration demonstrated significant energy savings. It achieved a 13% reduction for 90% stripping efficiency and a 21% reduction for 99% stripping efficiency. These savings are attributed to the increased ionic flux and shorter operating time enabled by the iEDFO design.

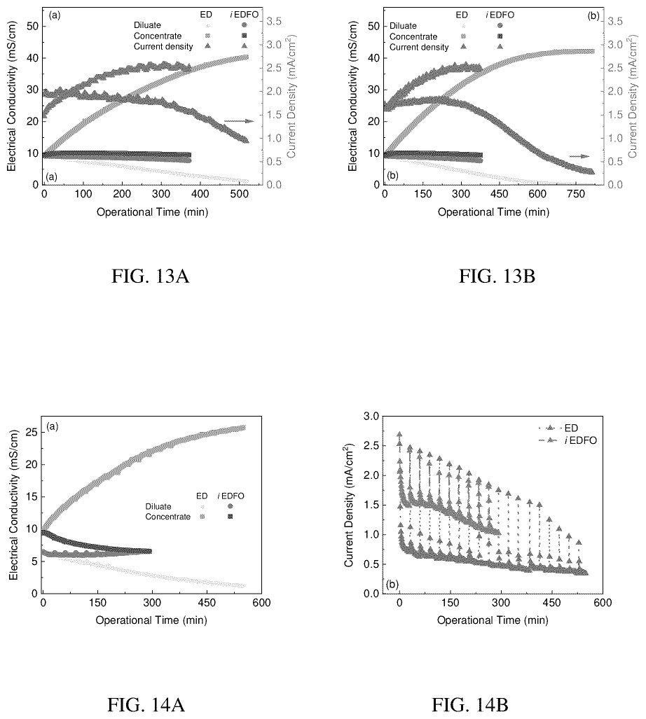

Although experiments using synthetic solutions have demonstrated the potential benefits of the iEDFO configuration, it is crucial to evaluate its performance with real digestate. This approach also allows the examination of ion-exchange membranes (IEMs) to assess the extent of fouling. FIG. 6 again highlights the superiority of the iEDFO configuration. It demonstrates significantly shorter operating times (292 min) compared to conventional ED (550 min) when treating real anaerobic digestate, which is attributed to the increased ion migration rate driven by higher current densities. In FIG. 14B, the peaks observed in the current density curve indicate the occurrence of electrodialysis reversal (EDR) when the same applied potential was reversed in polarity. The implementation of EDR is a typical practice to alleviate membrane fouling in the desalination industry. Even with EDR, the current density curve during real digestate treatment (pink in FIG. 14B) showed a much steeper decline compared to the synthetic water treatment (pink in FIG. 13A), suggesting fouling build-up over time. Nevertheless, iEDFO only experienced a 50% reduction in current density compared to over 80% in conventional ED, indicating a significant degree of fouling alleviation. Energy consumption analysis (Table 4) further revealed an overall 25% reduction in energy consumption for each of the three macronutrient ions found in Gresham anaerobic digestate when transitioning from ED→FO to iEDFO configurations, confirming our initial hypothesis.

TABLE 4
Energy Efficiency of ED→FO vs. iEDFO

| | Normalized Energy Consumption | | |
|---|---|---|---|
| | (Wh/mmol) | | |
| Nutrients | ED→FO | iEDFO | Energy Saving |
| Nitrogen | 0.448 ± 0.021 | 0.338 ± 0.014 | 25% |
| Phosphorus | 0.237 ± 0.007 | 0.171 ± 0.007 | |
| Potassium | 0.226 ± 0.009 | 0.171 ± 0.011 | |

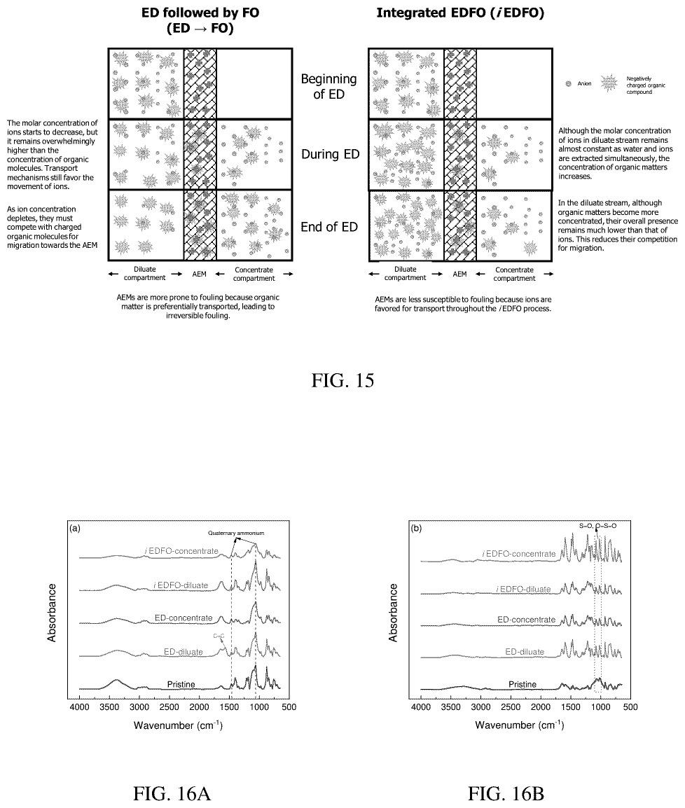

As illustrated in FIG. 15, the iEDFO configuration significantly reduced AEM fouling compared to the original ED→FO design. This reduction can be attributed to two factors: (1) the shortened exposure time between wastewater and membranes while processing the same volume of water and achieving the same stripping efficiency, and (2) the competing effects between negatively charged organic matter (OM) and anions when the diluate becomes excessively diluted (FIG. 15A).

In an ED system, ions move more readily by electric force compared to bulkier OM. When ED operates individually (ED→FO configuration), the high concentration of smaller anions dominates transport towards the AEMs. However, as the ED process progresses, the concentration of anions near the membrane surface significantly depletes. This allows negatively charged OM to eventually outcompete the remaining anions in carrying the current across the membranes. This enhanced selectivity towards organic foulants over time leads to severe fouling and decreased current efficiency, especially when the bulk ion concentration in the diluate becomes very low (FIG. 15A). In contrast, the iEDFO process gradually concentrates OM in the diluate compartment as water is extracted. However, ions remain the dominant species compared to organic foulants. This maintains favorable conditions for transporting desired nutrient ions (FIG. 15B). The phenomenon was initially observed through the variation of organic content in different streams throughout the treatment process (Table 5). Both configurations demonstrated excellent COD rejection capabilities of up to 97%. However, concerns remain regarding low-molecular-weight, charged dissolved organic matter (DOM). These compounds can form complexes with the positively charged functional groups grafted onto AEMs, leading to permanent fouling of those exchange sites, or they can pass through the membranes. DOC data revealed that while the individual ED rejected 83% of the DOM from the original digestate, the iEDFO configuration achieved a superior rejection rate of 96% on a mass basis. The greater DOM rejection with iEDFO indicates less DOM adsorbed onto the membrane or migrated through the membrane, thus supporting our explanation for the reduced AEM fouling with iEDFO.

TABLE 5
Organic Concentrations in Various Stages of ED→FO and iEDFO Processes
ED → FO

| | | Initial ED | Final ED Diluate / | Final ED Concentrate / | Final FO |
|---|---|---|---|---|---|
| | | Diluate/Digestate | Initial FO Feed | Initial FO Draw | Draw/Product |
| UV₂₅₄ | | 0.75 | 0.55 | 0.42 ± 0.1 | 0.12 ± 0.01 |
| DOC | (mg/L) | 1484 ± 15 | 1271 ± 36 | 1090 ± 56 | 236 ± 17 |
| COD | (mg/L) | 3331 ± 17 | 3258 ± 51 | 607 ± 4 | 53 ± 7 |

iEDFO

| | | Initial ED | Final ED Diluate / | Final FO |
|---|---|---|---|---|
| | | Diluate/Digestate | FO Feed | Draw/Product |
| UV₂₅₄ | | 0.74 ± 0.01 | 2.43 ± 0.08 | 0.08 ± 0.01 |
| DOG | (mg/L) | 1418 ± 21 | 8230 ± 1069 | 60 ± 3 |
| COD | (mg/L) | 3549 ± 86 | 21212 ± 1711 | 28 ± 4 |

* Initial ED concentrate did not contain any organic content

Membrane characterization techniques provided further insights into the proposed fouling mitigation mechanisms with iEDFO configuration. This section focuses on organic fouling of AEMs due to their stronger affinity for OM compared to CEMs. When disassembling the ED system after real digestate treatment, discoloration of AEMs was observed while no noticeable differences were seen on the CEMs.

AEMs are generally attracted to negatively charged OM containing carboxylate or sulfate groups due to the presence of positively charged functional groups (quaternary ammonium) embedded on the AEM surface. FTIR spectrometer was used to identify the functional groups present in both the pristine and fouled AEMs. As shown in FIG. 16A, fouled membranes displayed similar characteristic peaks to the pristine AEM, including O—H and N—H stretching vibrations at 3300 cm 1, —CH stretching vibrations around 3000 cm⁻¹, —CN stretching vibrations around 1470-1480 cm⁻¹, and N—CH₃ stretching vibrations around 1073 cm¹, respectively. Notably, the presence of the quaternary ammonium group, identified by the —CN and N—CH₃ vibrations, signifies the ion exchange functionality of the AEM. However, a new peak at 1568 cm⁻¹ appeared on the AEM facing the diluate of conventional ED that was applied in the ED→FO configuration. This peak could be attributed to the skeletal vibration of C═C bonds, typically associated with complex OM such as lignin, humic substances, and other polyaromatic hydrocarbons. Additionally, the increased peak intensity around 3000 cm⁻¹ suggests a higher presence of organic foulants on the AEM applied in the ED→FO configuration compared to the pristine membrane or the membrane applied in the iEDFO configuration.

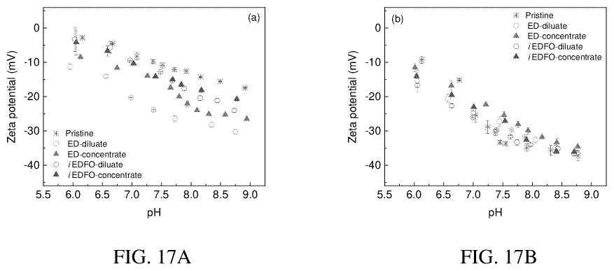

Greater organic fouling on the AEM in the ED→FO configuration is further evidenced by membrane surface zeta potential analysis at varying pH levels. As presented in FIG. 17A, the AEMs, particularly the side facing the diluate, in the ED→FO configuration exhibited a significantly more negative surface charge. This indicates a higher deposition of negatively charged OM on the membrane compared to the iEDFO configuration. Additionally, as expected, AEMs facing the diluate side experienced a greater drop in surface charge compared to those facing the concentrate side, particularly in the ED→FO configuration, due to their contact with much dirtier water in the diluate channel.

SEM-EDS analytical results for the pristine and fouled IEMs are summarized in Table 6. The pristine AEMs showed the presence of two major elements: carbon (52.5%) and fluoride (21.3%), indicating the use of polyvinylidene fluoride in the supporting polymer matrix. For the fouled AEMs applied in the ED→FO configuration, both sides of the membrane demonstrated a significant increase in carbon and a decrease in fluoride due to the deposition of organics. In contrast, the changes in the major elements composition were much less in the AEM applied in the iEDFO configuration, indicating less fouling.

TABLE 6
IEMs Characterization: elemental composition (atomic %) and ion exchange capacity (IEC)

| | Anion Exchange Membrane | | | | | | | Cation Exchange Membrane | | | | |
|---|---|---|---|---|---|---|---|---|---|---|---|---|
| | Elemental Composition (%) | | | | | | IEC (meq/g) | Elemental Composition (%) | | | | IEC (meq/g) |
| | C | N | O | F | Si | Cl | (n = 2) | C | O | Na | S | (n = 2) |
| Pristine | 52.5 | 7.6 | 6.1 | 21.3 | N/A | 12.4 | 1.42 ± 0.06 | 70.1 | 10.3 | 4.6 | 14.7 | 0.92 ± 0.01 |
| ED facing diluate | 71.3 | 3.2 | 8.9 | 3.9 | 7.1 | 5.6 | 1.27 ± 0.07 | 74.7 | 14.6 | 3.3 | 7.4 | 0.82 ± 0.04 |
| ED facing concentrate | 77 | 2 | 7.3 | 1.4 | N/A | 12.3 | | 72.3 | 12.1 | 5.2 | 9.4 | |
| i EDFO facing diluate | 48.4 | 6 | 9.7 | 25.7 | 6.8 | 7.9 | 1.31 ± 0.06 | 75.1 | 16.3 | 4 | 4.6 | 0.89 ± 0.04 |
| i EDFO facing concentrate | 60.9 | 6.7 | 10.7 | 12 | N/A | 9.3 | | 71.7 | 9.2 | 3 | 11 | |

Compared to AEMs, CEMs are much less susceptible to organic fouling due to their inherently negatively charged surface (FIG. 17B). FTIR spectra detected the characteristic peaks of CEMs: symmetric and asymmetric stretching vibrations of the S═O bonds (1030-1080 cm⁻¹) and O═S═O stretching vibration (1120-1170 cm⁻¹). The FTIR spectra (FIG. 16B) and elemental analysis (Table 6) indicate the CEMs contain typical sulfonic exchange groups with sodium as the mobile ions. Both zeta potential (FIG. 17B) and elemental analysis (Table 6) results highlighted minimal changes to the CEM after wastewater treatment, confirming that CEMs more resistant to fouling compared to AEM.

Finally, changes in the membrane IEC were determined (Table 6). As anticipated, a slight decrease in IEC was observed in both CEMs and AEMs due to organic fouling and scaling when treating real wastewater. However, this mild drop in IEC, ranging from approximately 4% to 10%, demonstrates the fouling-resistant properties of ED compared to other pressure-driven membrane-based separation.

In view of the many possible embodiments to which the principles of the disclosed invention may be applied, it should be recognized that the illustrated embodiments are only preferred examples of the invention and should not be taken as limiting the scope of the invention.

What is claimed is:

1. A method comprising:
introducing liquid digestate that includes at least one organic contaminant, at least one microbial contaminant, and at least one charged nutrient species into an electrodialysis stack thereby separating the liquid digestate into (a) a contaminant-rich diluate stream that includes the at least one organic contaminant and the at least one microbial contaminant and (b) a nutrient species-rich concentrate stream that includes the at least one nutrient species; and
directly introducing the diluate stream into a forward osmosis module as a feed stream and simultaneously directly introducing the nutrient species-rich concentrate stream into the forward osmosis module as a draw stream thereby producing (c) a water product that includes the at least one nutrient species and that is substantially free of the at least one organic contaminant and the at least one microbial contaminant and (d) a waste stream that includes the at least one organic contaminant and the at least one microbial contaminant,
wherein a concentration of the charged nutrient species in the concentrate stream is sufficient for generating a stable osmotic pressure difference between the draw stream and the feed stream in the forward osmosis module.

2. The method of claim 1, wherein the method provides simultaneous nutrient and water recovery.

3. The method of claim 1, wherein the method has a stable current density in the electrodialysis stack.

4. The method of claim 2, wherein the method has a stable current density in the electrodialysis stack.

5. The method of claim 1, further comprising recirculating the water product and the waste stream back into the electrodialysis stack.

6. The method of claim 4, further comprising recirculating the water product and the waste stream back into the electrodialysis stack.

7. The method of claim 1, wherein the electrodialysis stack has an applied voltage of 1 to 6 V/cell pair.

8. The method of claim 1, wherein the charged nutrient species is NH⁴⁺, NO₃⁻, NO₂⁻, PO₄³⁻, K⁺, Na⁺, Ca²⁺, Mg²⁺, Cl⁻, or SO₄²⁻.

9. The method of claim 1, wherein the liquid digestate includes NH⁴⁺, NO₃⁻, PO₄³⁻ and K⁺ as charged nutrient species.

10. The method of claim 1, wherein the water product (c) is applied to at least one type of plant crop.

11. The method of claim 1, wherein the liquid digestate includes an organic contaminant or microbial contaminant that includes at least one antibiotic-resistance gene.

12. The method of claim 1, wherein the liquid digestate includes at least one antibiotic.

13. A method comprising:
introducing liquid digestate that includes at least one organic contaminant, at least one microbial contaminant, and at least one charged nutrient species into an electrodialysis system thereby separating the liquid digestate into (a) a contaminant-rich diluate stream that includes the at least one organic contaminant and the at least one microbial contaminant and (b) a nutrient species-rich concentrate stream that includes the at least one nutrient species; and
introducing the diluate stream into a forward osmosis system as a feed stream and simultaneously introducing the nutrient species-rich concentrate stream into the forward osmosis system as a draw stream thereby producing (c) a water product that includes the at least one nutrient species and that is substantially free of the at least one organic contaminant and the at least one microbial contaminant and (d) a waste stream that includes the at least one organic contaminant and the at least one microbial contaminant.

14. The method of claim 13, wherein the charged nutrient species is NH⁴⁺, NO₃⁻, NO₂⁻, PO₄³⁻, K⁺, Na⁺, Ca²⁺, Mg²⁺, Cl, or SO₄²⁻.

15. The method of claim 13, wherein the liquid digestate includes NH⁴⁺, NO₃⁻, PO₄³⁻, and K⁺ as charged nutrient species.

16. The method of claim 13, wherein the water product (c) is applied to at least one type of plant crop.

17. The method of claim 13, wherein the liquid digestate includes an organic contaminant or microbial contaminant that includes at least one antibiotic-resistance gene.

18. The method of claim 13, wherein the liquid digestate includes at least one antibiotic.

19. A system comprising:
an electrodialysis stage that includes an inlet for receiving a liquid digestate that includes at least one organic contaminant, at least one microbial contaminant, and at least one charged nutrient species, a first outlet for a contaminant-rich diluate stream that includes the at least one organic contaminant and the at least one microbial contaminant, and a second outlet for a nutrient species-rich concentrate stream that includes the at least one nutrient species; and
a forward osmosis stage having a draw side and a feed side, wherein the draw side is in fluid communication with the nutrient species-rich concentrate stream and the feed side is in fluid communication with the contaminant-rich diluate stream.

20. The system of claim 19, wherein the electrodialysis stage includes at least one cation exchange membrane and at least one anion exchange membrane disposed between a terminal anode and a terminal cathode.

21. The system of claim 19, wherein a semipermeable membrane is located between the draw side and the feed side.

22. The system of claim 19, wherein the forward osmosis stage includes a first inlet for the draw side that is in direct fluid communication with the second outlet for the nutrient species-rich concentrate stream of the electrodialysis stage, and the forward osmosis stage includes a second inlet for the feed side that is in direct fluid communication with the first outlet for the contaminant-rich diluate stream of the electrodialysis stage.

23. The system of claim 19, wherein the system is configured for recirculating the nutrient species-rich concentrate stream and the contaminant-rich diluate stream.

24. The system of claim 19, wherein the liquid digestate includes NH⁴⁺, NO₃⁻, PO₄³⁻ and K⁺ as charged nutrient species.
